(19) United States
(12) Patent Application Publication
(10) Pub. No.: US 2026/0239320 A1
(43) Pub. Date: Aug. 13, 2026

(54) NETWORK NODE AND METHOD IN A COMMUNICATIONS NETWORK

(71) Applicant: Telefonaktiebolaget LM Ericsson (publ), Stockholm (SE)

(72) Inventors: Bo GÖRANSSON, SOLLENTUNA (SE); Jing RAO, SOLLENTUNA (SE); Martin ALM, MÖLNLYCKE (SE)

(73) Assignee: Telefonaktiebolaget LM Ericsson (publ), Stockholm (SE)

(21) Appl. No.: 19/154,454

(22) PCT Filed: Feb. 8, 2023
(86) PCT No.: PCT/EP2023/053087

§ 371 Date: Aug. 7, 2025

(51) Int. Cl. H04W 72/0453; H04W 16/28; H04W 72/044

(52) U.S. Cl. CPC H04W 72/0453; H04W 16/28; H04W 72/046

(57) ABSTRACT

A method performed by a network node network is provided. The method is for handling beam squint in multiple carrier frequencies supported by the network node in a wireless communications The network node obtains a set of beam tables comprising a beam table for each carrier frequency out of the multiple carrier frequencies supported by the network node. The network node obtains from the set of beam tables, a beam table designed for a primary carrier frequency comprised in the multiple carrier frequencies. The primary carrier frequency is for predetermined critical data. The network node performs the predetermined critical data transmissions to and/or receptions from a UE on the primary carrier frequency, by applying the obtained beam table designed for the primary carrier frequency and thereby being prevented from beam squint.

### TECHNICAL FIELD

Embodiments herein relate to a network node and a methods therein. In some aspects, they relate to handling for handling beam squint in multiple carrier frequencies supported by the network node in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

5G NR may be used for so-called millimeter wave (mmWave) or FR2 frequency bands. The mmWave or FR2 frequency bands may be found in. 24.25 GHz-52.6 GHz. frequency band. The benefit of defining these bands with high carrier frequency is the availability of large bandwidths. The drawback is a higher pathloss that is experienced on mmWave frequencies. One way to overcome this increased pathloss is to apply a larger antenna and to introduce beamforming. By this the Equivalent Isotropic Radiated Power (EIRP) and Equivalent Isotropic Sensitivity (EIS) can be kept high without increasing the radiated power too much.

NR FR2 mmWave systems are normally deployed with radio nodes using beamforming. A common way to implement this beamforming is to use a codebook. That is, a pre-defined set of beamforming vectors stored in a table and may be addressed by an index. A typical layout of beam peak directions is shown in FIG. 1. FIG. 1 illustrates a beamforming codebook that generates beams covering a certain coverage area, wherein the x-axis represents the azimuth direction φ and the y-axis represents the elevation direction θ.

Note that the beams may either be generated using Analog Beamforming (ABF) where analog phase shifters and gain control is used between the ports of the antenna array. Alternatively, wherein the beams may be generated by using Digital Beamforming (DBF) in a digital domain, where a complex coefficient representing phase and amplitude, is multiplied on the signal before conversion to analog domain on each branch.

Another typical feature of FR2 based systems is the large, supported bandwidth. There are several bands standardized for FR2 operation, most of them covering several GHz of bandwidth. A typical radio product will support a large total bandwidth divided into several channels with different carrier frequencies. As an example, assume that the radio support 10×100 MHz, that is a total bandwidth of 1 GHz.

The beam weights needed to create a beam table such that depicted in FIG. 1 are normally frequency dependent. The array response vector, that is, the function mapping a plane wave impinging on the array to phase shifts between elements in the array is normally dependent on the distance between the elements of the array, and on the frequency (or wavelength) of the carrier. That is, the beamforming weights that generate a beam pointing in the direction θ and φ will depend on the carrier frequency of the specific channel. In the rest of this disclosure, we will describe the case with a uniform linear array (ULA), that is, the direction is described by a single parameter, here θ, but the method disclosed here is easily extended to cover the 2-dimensional case where a beam points in direction (θ, φ).

The array response vector for a m-element ULA is given by

$$a ( θ ) = [ \begin{matrix}1 \\ {e}^{j 2 π \frac{d}{λ} sin ( θ )} \\ ⋮ \\ {e}^{j 2 π ( m - 1 ) \frac{d}{λ} sin ( θ )}\end{matrix} ]$$

where d represent the element distance, λ, is the wavelength of the carrier signal, and θ is the direction of the planewave. A typical beamforming vector is then chosen as the spatially match filter, that is a vector dependent of the direction for this very carrier frequency (wavelength).

In order to limit the number of beamforming vectors, beams are not generated in all possible directions. The pointing direction of the beams is designed to have certain overlap between the beams coverage angles. As shown in FIG. 1 a reasonable spatial sample interval would be a few degrees.

When a large bandwidth is supported in a system with beamforming, the frequency dependency of the beam pointing direction may be problematic. A beam defined for a certain frequency will point in a slightly different direction when applied at another frequency. This effect is a problem and is referred to as beam squint.

Beam squint occurs since time-delay and phase shift is only equivalent for a narrow bandwidth. If the beamforming is implemented using phase shifters, or complex multiplications, in a DBF implementation, the beam will point in a slightly different direction on all carriers except the one where the frequency matches the design of the beamformer. One solution to this problem would be to define one beam table per carrier, where the explicit carrier frequency has been used to calculate the entries of the beam table. The drawback is that many beam tables are needed, and since memory is a scarce resource in the radio this would contribute to implementation complexity and increased power consumption.

The problem will be described more in detail below.

### SUMMARY

As a part of developing embodiments herein a problem was identified by the inventors and will first be discussed.

When carrier aggregation (CA) is used, one carrier is defined as primary cell (Pcell) or primary cell of secondary cell group (PSCell) also referred to as primary carrier frequency. This frequency carrier carries most of the important channels comprising critical data, such as Synchronization Signal Block (SSB) data, synchronization and broadcast data, control channels data etc. For that reason, it would be of interest to provide the best link budget here.

The primary carrier frequency is defined per UE, but to increase system efficiency many UEs may be allocated to the same primary carrier frequency, this since allocating control channels on many carriers would increase the overhead and reduce resources available for data transmission. However, when very many UEs should be supported by the wireless communications system, it is possible to support more than one primary carrier frequency.

As mentioned above, the total available bandwidth is normally divided into more narrow channels. As exemplified here, a total bandwidth of 1 GHz is divided into 10×100 MHz channels. To utilize all available bandwidth, the system uses carrier aggregation, CA. In such a case one specific carrier is chosen as the primary carrier (or cell) which is used for e.g., broadcast and control channels. When data is transmitted, several secondary frequency carriers, also referred to as secondary cells, associated with the primary frequency carrier may be used to increase the total available bandwidth.

A problem with using a single codebook for all carriers within a band is the beam squint. As noted from the array response vector, a unique beamforming vector is needed for each carrier since the array response vector is frequency or wavelength dependent. In the specific situation described above, 10 different beam tables would be needed if all 10 carriers should be transmitted in the same direction θ. This would require a very large memory to store all possible beam weights. Note that for the example described in FIG. 1 the beam table comprises 34×8 different beamformers, and thus with a wideband system supporting 10 carriers, 34×8×10 beamformer needs to be stored. To provide high beamforming gain, a large number of antenna elements is normally used, and hence the size of each entry in the beam table may comprise several hundred elements. Since memory is expensive, this is prohibitive and only one table may be stored in the radio.

An object of embodiments herein is to improve the performance of a wireless communications network by providing an efficient way of handling beam squint.

According to an aspect of embodiments herein, the object is achieved by a method performed by a network node for handling beam squint in multiple carrier frequencies supported by the network node in a wireless communications network. The network node obtains a set of beam tables comprising a beam table for each carrier frequency out of the multiple carrier frequencies supported by the network node. The network node obtains from the set of beam tables; a beam table designed for a primary carrier frequency comprised in the multiple carrier frequencies. The primary carrier frequency is for predetermined critical data. The network node performs the predetermined critical data transmissions to and/or receptions from a UE on the primary carrier frequency, by applying the obtained beam table designed for the primary carrier frequency and thereby being prevented from beam squint. The network node performs predetermined less critical data transmissions to and/or receptions from the UE on one or more secondary carrier frequencies comprised in the multiple carrier frequencies, by applying the obtained beam table relating to the primary carrier frequency and thereby suffering from beam squint.

According to another aspect of embodiments herein, the object is achieved by a network node configured to handle beam squint in multiple carrier frequencies supported by the network node in a wireless communications network. The network node is further configured to:
obtain a set of beam tables comprising a beam table for each carrier frequency out of the multiple carrier frequencies supported by the network node,
obtain from the set of beam tables, a beam table designed for a primary carrier frequency comprised in the multiple carrier frequencies, which primary carrier frequency is adapted to be for predetermined critical data,
perform the predetermined critical data transmissions to, and/or receptions from, a UE on the primary carrier frequency, by applying the obtained beam table designed for the primary carrier frequency and thereby being prevented from beam squint, and
perform predetermined less critical data transmissions to and/or receptions from the UE on one or more secondary carrier frequencies comprised in the multiple carrier frequencies, by applying the obtained beam table relating to the primary carrier frequency and thereby suffering from beam squint.

In this way the beam squint is steered towards the secondary carrier frequencies where the less critical data is sent which may experience slightly lower gain, while the critical data is allocated to the most important carrier, i.e. the primary carrier frequency which does not suffer from any beam squint and thereby provides a maximum beam gain and sensitivity. This results in an efficient way of handling beam squint which improves the performance of the wireless communications network.

### BRIEF DESCRIPTION OF THE DRAWINGS

Examples of embodiments herein are described in more detail with reference to attached drawings in which:

FIG. 1 is a schematic diagram illustrating prior art.

FIG. 2 is a schematic block diagram illustrating embodiments of a wireless communications network.

FIG. 3 is a flowchart depicting an embodiment of a method in a network node.

FIG. 4 is a flowchart depicting an embodiment of a method.

FIG. 5 is a schematic block diagram illustrating embodiments of a network node.

FIG. 6 schematically illustrates a telecommunication network connected via an intermediate network to a host computer.

FIG. 7 is a generalized block diagram of a host computer communicating via a base station with a user equipment over a partially wireless connection.

FIGS. 8-11 are flowcharts illustrating methods implemented in a communication system including a host computer, a base station, and a user equipment.

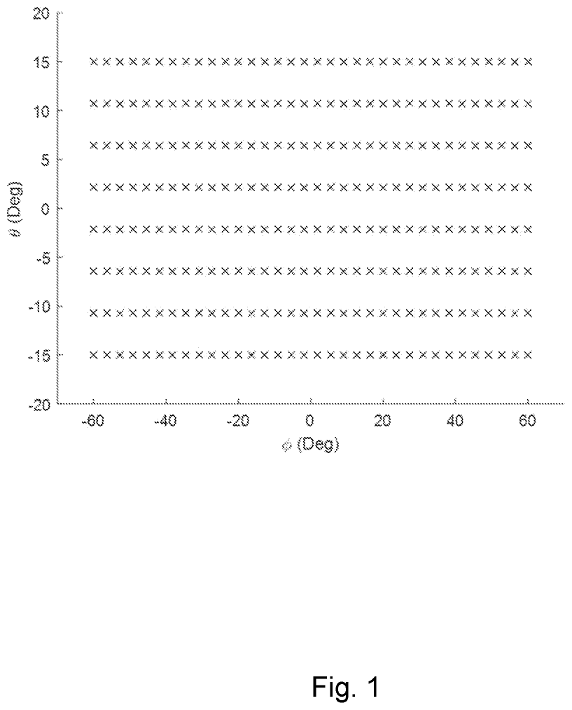

### DETAILED DESCRIPTION

Some example embodiments herein is targeting a wireless communications system supporting several carriers, and relate to beam table, also referred to as codebook, selection to handling beam squint.

E.g. a RAN system, such as a management node, comprises all beam tables for all possible frequencies, but at system start up, e.g. RAN system startup, the beam table associated with a primary carrier, also referred to as cell, is loaded into the network node, and is then used for all transmissions and/or receptions even in the case of CA.

Embodiments herein may e.g. provide the following advantages. Since many of the link budget constrained channels are related to the primary cell it is important to maximize the beamforming gain for this particular carrier. Hence, at startup of the system, such as a RAN system, when the primary cell is decided, the beam table associated to this particular frequency should be loaded into the network node 110. By this max beam gain and sensitivity is allocated to the most important carrier, while other carriers may suffer from beam squint and hence experience slightly lower gain.

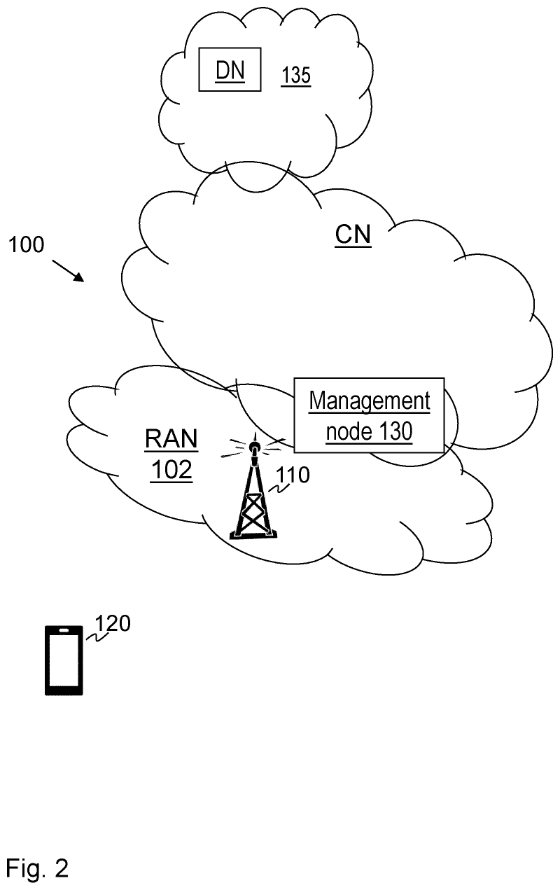

FIG. 2 is a schematic overview depicting a wireless communications network 100, such as e.g. a wireless communications network, wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

The wireless communications network 100 comprises one or more RANs 102.

Network nodes, such as a network node 110, operate in the wireless communications network 100, e.g. in a RAN 102. The network node 110 e.g. provides a number of cells and may use these cells for communicating with other radio nodes, such as e.g. a UE 120. The network 110 may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 110 depending e.g. on the radio access technology and terminology used.

Network nodes, such as the UE 120, operate in the wireless communications network 100, e.g. in the RAN 102. The UE 120 may e.g. be an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. the RAN 102, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

A management node 130 operates in the wireless communications network 100. The management node 130 may be an Operation and Management node, e.g. in an (OAM) system. The network node 110 has access to the management node for storing and obtaining a set of beam tables. This will be described below.

Methods herein may in one aspect be performed by the first radio node 110. As an alternative, a Distributed Node (DN) and functionality, e.g. comprised in a cloud 135 as shown in FIG. 2, may be used for performing or partly performing the methods of embodiments herein.

Beam tables for multiple carrier frequencies may be available at the management node 130, or e.g. in the cloud 135. At startup of the network node 110 or RAN, the beam table corresponding to the primary carrier frequency may be pushed to the network node 110.

Multiple beam tables depending on the carrier frequency of each component carrier are defined, but at start up, a beam table corresponding to the primary carrier frequency, also referred to as primary cell (Pcell), is loaded into the network node 110. The beam table corresponding to the primary carrier frequency is used when transmitting critical data on the on the primary carrier frequency and the beam is thereby being prevented from beam squint. The beam table corresponding to the primary carrier frequency is further used on any secondary carrier frequency when transmitting less critical data and the beam thereby suffers from beam squint any carrier.

A number of embodiments will now be described, some of which may be seen as alternatives, while some may be used in combination.

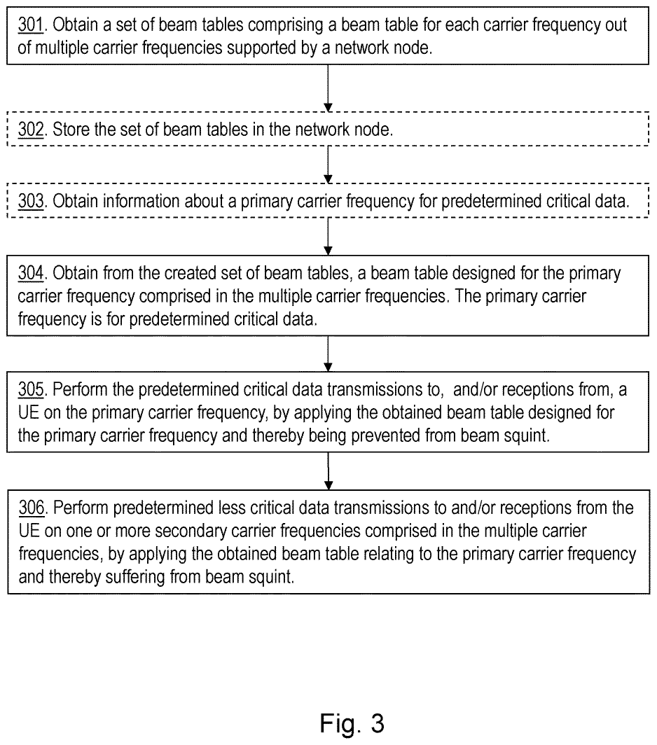

FIG. 3 shows exemplary embodiments of a method performed by the network node 110, 120. The method may be performed by any of the UE 120 or the network node 110, the node performing the method is therefore referred to as the network node 110, 120 herein. The method is for handling, also referred to as managing, beam squint in multiple carrier frequencies supported by the network node 110, 120 in the wireless communications network 100. The multiple carrier frequencies supported by the network node 110 comprises at least one primary carrier frequency and one or more secondary carrier frequencies.

The method comprises the following actions, which actions may be taken in any suitable order. Optional actions are referred to as dashed line boxes in FIG. 3.

### Action 301

The network node 110, 120 obtains a set of beam tables comprising a beam table for each carrier frequency out of the multiple carrier frequencies supported by the network node 110, 120.

A beam table may also be referred to as a codebook.

A set of beam tables may be created, also referred to as designed, specifically for each base station such as also for the network node 110, 120. The created set of beam tables may then be loaded into the management node 130. The network node 110, 120 may then obtain the set of beam tables by downloading it from the management node 130. In some embodiments the network node 110, 120 obtains the set of beam tables by being pre-configured with the set of beam tables.

Thus these beam tables may e.g. be available for the network node 110, 120 in the management node 130, e.g. in an OAM system. At startup of the RAN, a beam table corresponding to a chosen Pcell and/or PSCell frequency, referred to as primary carrier frequency will be loaded into the network node 110, 120 and hence used when running the system.

In this way the set of beam tables is not using the memory of the network node 110, 120, only the beam table corresponding to the beam table designed for the primary carrier frequency will be loaded into the network node 110, 120 and thereby using the memory.

The available beam tables may be designed in the Management Object Model (MOM), and the one corresponding to Pcell may be loaded at system startup. Here I thing the management node is the one handling the Management Object Model (MOM)

### Action 302

The network node 110, 120 may store the obtained set of beam tables in the network node 110, 120.

### Action 303

In some embodiments, the network node 110, 120 obtains information about a primary carrier frequency, also referred to as a Pcell, for predetermined critical data, e.g., a new primary carrier frequency. The primary carrier frequency is comprised in the multiple carrier frequencies. Critical data when used herein e.g. means the most important data, such as synchronization signal Primary Synchronization Signal (SSS) Service (PSS) and/or Secondary Synchronization Signal (SSS)/Physical Broadcast Channel (PBCH), System Information Blocks (SIBs), Physical Radom Access Channel (PRACH) and other messages for initial access etc.

There may be more than one primary carrier frequency. In some embodiments, information about the primary carrier frequency for the predetermined critical data comprises information about two or more primary carrier frequencies for predetermined critical data. The primary carrier frequency may comprise two or more primary carrier frequencies which are comprised in the multiple carrier frequencies.

The predetermined critical data may e.g. comprise at least one or more out of synchronization data, broadcast data, and control data. Predetermined when used herein may e.g. mean configured or decided beforehand.

The network node 110, 120 may further obtains information about a secondary carrier frequency for predetermined less critical data. Less critical data when used herein e.g. means payload data.

In some embodiments, the one or more secondary carrier frequencies for less critical data, may comprise user data, a number of supporting signaling such as scheduling grants carried on the Physical Downlink Control Channel (PDCCH), Chanel State Information—Reference Signal (CSI-RS) for channel information etc.

Less critical data when used herein e.g. means data that is not the most important data, less important data that is not critical in the sense that it may impact on the UE (120) getting connected to the network node 110, 120 and obtaining system information.

The critical data is more critical than the less critical data.

### Action 304

The network node 110, 120 obtains, e.g., loads, from the set of beam tables, a beam table designed for the primary carrier frequency, in some embodiments the one or more the primary carrier frequencies, comprised in the multiple carrier frequencies. As mentioned above, the primary carrier frequency is for predetermined critical data.

Any of the network node 110, 120 and the managing node 130 may select the beam table designed for the primary carrier frequency, which then is obtained by the network node 110, 120.

In some embodiments, the network node 110, 120 obtains the beam table designed for the primary carrier frequency is performed when any one out of:
starting the RAN 102 in which the network node 110, 120 is operating,
restarting the RAN 102 in which the network node 110, 120 is operating,
deciding to change which carrier frequency is allocated as primary carrier frequency.

In some embodiments comprising two or more primary carrier frequencies, the network node 110, 120 obtains of the beam table relating to the primary carrier frequency, by obtaining from the set of beam tables, any one out of:
a respective beam table for each of the two or more allocated primary carrier frequencies, or
a respective beam table for at least some of the two or more allocated primary carrier frequencies, or
a beam table to be used for all of the two or more allocated primary carrier frequencies.

In some embodiments, the obtained beam table designed for the primary carrier frequency may be stored in the network node 110, 120, which network node 110, 120 may be a base station. This is an advantage since only one beam table, the beam table designed for the primary carrier frequency may need to be stored.

### Action 305

The network node 110, 120 then performs the predetermined critical data transmissions to, and/or receptions from, the UE 120 on the primary carrier frequency. This is performed by applying the obtained beam table designed for the primary carrier frequency and the predetermined critical data transmission is being prevented from beam squint.

The beam squint is prevented since the beam table being designed for the primary carrier frequency causes no beam squint when transmitting on the carrier frequency it is designed for.

In some embodiments comprising two or more primary carrier frequencies, the network node 110, 120 performs the predetermined critical data transmissions to and/or receptions on the two or more primary carrier frequencies, by applying the respective, e.g., one or more, obtained beam table relating to the two or more primary carrier frequencies and thereby the predetermined critical data transmissions are being prevented from beam squint.

### Action 306

The network node 110, 120 performs predetermined less critical data transmissions to and/or receptions from the UE 120 on one or more secondary carrier frequencies comprised in the multiple carrier frequencies. This is performed by applying the obtained beam table relating to the primary carrier frequency and thereby these predetermined less critical data transmissions/receptions are suffering from beam squint.

The beam table designed for the primary carrier frequency is thus used both for the primary carrier frequency causing no beam squint, and the secondary carrier frequency causing beam squint. Thus, in this way, the handling or managing of the beam squint in multiple carrier frequencies, comprises that the critical data is transmitted/received in the primary carrier frequency and is thereby prevented from suffering from beam squint. While, less critical data is transmitted/received in the secondary carrier frequencies and is thereby allowed to suffer from beam squint. The critical data is more critical than the less critical data.

So, according to embodiments herein, only one beam table, the beam table designed for the primary carrier frequency requires to be stored and the critical data is transmitted/received in the primary carrier frequency without beam squint.

As mentioned above, the method may be performed by any of the UE 120 or the network node 110, and the node performing the method is therefore referred to as the network node 110, 120 herein. Even a UE such as the UE 120 with a larger array, e.g., a Customer Premises Equipment (CPE) for fixed wireless access, may experience beam squint and therefore use a beam table designed for Pcell.

The UE 120 may obtain the beam table designed for the primary carrier frequency, by detecting a Pcell from SSB and then use the correct beam table for the primary carrier frequency.

The UE may perform 3GPP P3 beam management based on CSI-RS. In order to minimize the overhead, the network node 110 may only want to send CSI-RS in PSCell and/or PCell. In that case, the UE 120 may only measure on PSCell and/or PCell. Therefore, the UE 120 may load only one beam table optimized based on PSCell/PCell carrier frequency and select the best beam in this most critical cell based on CSI-RS measurement, in order to make sure no beam squint in this cell.

Embodiments herein such as the embodiments mentioned above will now be further described and exemplified. The text below is applicable to and may be combined with any suitable embodiment described above.

In short, example embodiments herein comprise the following:

The network node 110, 120 obtains the set of beam tables comprising a suitable beam table for all respective possible carrier frequencies supported by the network node 110, 120.

The set of beam tables may be supplied to the network node 110, 120 together with hardware. The set of beam tables may be stored in the network node 110, 120 and also in the management node 130. When a set of new beam tables for the network node is created 110 it may be loaded into the managing node 130 and from there loaded to the network node 110, 120.

The set of beam tables may be stored and available in the managing node 130, also referred to as a configuration node, e.g. in the OAM system, or the network node 110, 120. At startup of the RAN, a primary carrier frequency is selected by e.g., any of the network node 110, 120 and the managing node 130, and a beam table corresponding to a selected primary carrier frequency is loaded into the network node 110, 120, such as e.g., configuring the network node 110, 120 by transferring the corresponding beam table to the network node 110, 120.

Hence the primary carrier frequency loaded into the network node 110, 120 is used when running the RAN. If several primary carrier frequencies are used by the RAN, several beam tables may be loaded into the network node 110, 120, if supported by the network node 110, 120. Alternatively, the beam table that best matches an allocated primary carrier frequency is loaded into the network node 110, 120.

If several carrier frequencies are allocated as primary carrier frequencies, either define them on carriers as critical, also referred to as most important, and load its corresponding beam table into the network node 110, 120 or chose a beam table that best represents each primary carrier frequency and transfer it to the network node 110, 120. If the network node 110, 120 only supports the storage of one beam table, obtain, e.g., select, the beam table representing a frequency in between the two (or more) allocated primary carrier frequencies.

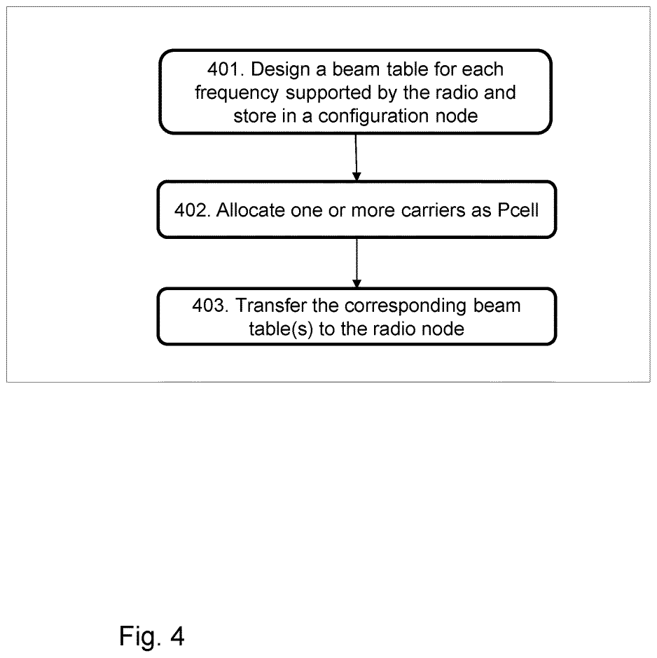

In an example of embodiments herein, the method is briefly described as follows and as depicted in FIG. 4 401. The network node 110, 120 designs a beam table for each frequency supported by the radio and store in a configuration node. This is related to and may be combined with Action 301 described above.

402. The network node 110, 120 allocates one or more carriers as primary carrier frequencies. This is related to and may be combined with Action 303 described above.

403. Corresponding beam tables are transferred to the network node 110, 120. This is related to and may be combined with Action 304 described above.

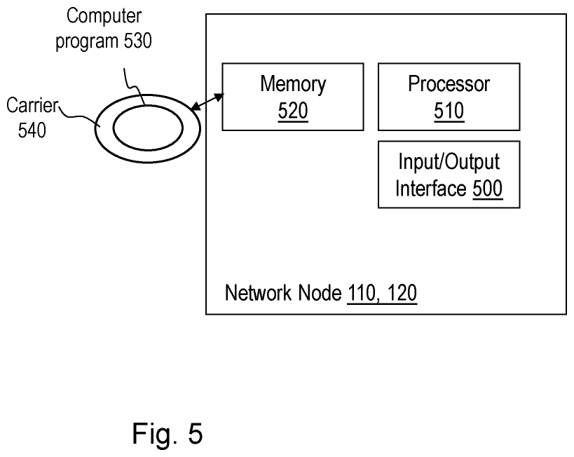

FIG. 5 illustrates an example of an arrangement in the network node 110, 120.

The network node 110, 120 is configured to handle beam squint in multiple carrier frequencies supported by the network node 110, 120 in the wireless communications network 100.

The network node 110, 120 may comprise an input and output interface 500 configured to communicate e.g., with any of the networking entities operating in the wireless communications network 100 of embodiments herein such as e.g., the UE 120 and/or the management node 130. The input and output interface 600 may comprise a receiver, e.g., wired and/or wireless, (not shown) and a transmitter, e.g., wired and/or wireless, (not shown).

The network node 110, 120 is further configured to obtain a set of beam tables comprising a beam table for each carrier frequency out of the multiple carrier frequencies supported by the network node 110, 120.

The network node 110, 120 is further configured to obtain from the set of beam tables, a beam table designed for a primary carrier frequency comprised in the multiple carrier frequencies. The primary carrier frequency is adapted to be for predetermined critical data.

The network node 110, 120 is further configured to perform the predetermined critical data transmissions to, and/or receptions from, a UE 120 on the primary carrier frequency, by applying the obtained beam table designed for the primary carrier frequency and thereby being prevented from beam squint.

The network node 110, 120 is further configured to perform predetermined less critical data transmissions to and/or receptions from the UE 120 on one or more secondary carrier frequencies comprised in the multiple carrier frequencies, by applying the obtained beam table relating to the primary carrier frequency and thereby suffering from beam squint.

In some embodiments, the network node 110, 120 is further configured to obtain the beam table designed for the primary carrier frequency when, e.g. in response to, any one out of:
starting a Radio Access Network, RAN, 102 in which the network node 110, 120 is operating,
restarting the RAN 102 in which the network node 110, 120 is operating,
deciding to change which carrier frequency is allocated as primary carrier frequency.

In some embodiments, any one or more out of:
the primary carrier frequency for predetermined critical data is adapted to comprise at least one or more out of synchronisation data, broadcast data, and control data, and
the one or more secondary carrier frequencies, for less critical data, is adapted to comprise at least user data, a number of supporting signaling and some broadcast data.

In some embodiments, the network node 110, 120 is further configured to any one or more out of: Store the set of beam tables in the network node 110, 120, and obtain information about the primary carrier frequency for predetermined critical data. The primary carrier frequency may in these embodiments be adapted to be comprised in the multiple carrier frequencies.

In some embodiments, the network node 110, 120 is further configured to obtain the information about the primary carrier frequency for predetermined critical data, by: obtaining information about two or more primary carrier frequencies for predetermined critical data, which two or more primary carrier frequencies are adapted to be comprised in the multiple carrier frequencies.

In some embodiments, the network node 110, 120 is further configured to obtain from the set of beam tables, the beam table relating to the primary carrier frequency by obtaining from the set of beam tables, any one out of:
a respective beam table for each of the two or more allocated primary carrier frequencies, or
a respective beam table for at least some of the two or more allocated primary carrier frequencies, or
a beam table to be used for all of the two or more allocated primary carrier frequencies.

In some embodiments, the network node 110, 120 is further configured to perform the predetermined critical data transmissions and/or receptions on the primary carrier frequency, by applying the obtained beam table relating to the primary carrier frequency and thereby being prevented from beam squint, is performed by: performing the predetermined critical data transmissions to and/or receptions on the two or more primary carrier frequencies, by applying the respective obtained beam table relating to the two or more primary carrier frequencies and thereby being prevented from beam squint.

In some embodiments, the obtained beam table designed for the primary carrier frequency is adapted to be stored in the network node 110, 120, e.g., a base station.

The network node 110, 120 may further be configured to perform any of the above-mentioned actions and/or examples, e.g., in any suitable manner and in any suitable order.

The embodiments herein may be implemented through a respective processor or one or more processors, such as at least one processor 510 of a processing circuitry in the network node 110, 120 depicted in FIG. 5, together with computer program code for performing the functions and actions of the embodiments herein. The program code mentioned above may also be provided as a computer program product, for instance in the form of a data carrier carrying computer program code for performing the embodiments herein when being loaded into the network node 110, 120. One such carrier may be in the form of a CD ROM disc. It is however feasible with other data carriers such as a memory stick. The computer program code may furthermore be provided as pure program code on a server and downloaded to the network node 110, 120.

The network node 110, 120 may further comprise a memory 520 comprising one or more memory units. The memory 520 comprises instructions executable by the processor in the network node 110, 120. The memory 520 is arranged to be used to store instructions, data, configurations, measurements, parameters, and applications to perform the methods herein when being executed in the network node 110, 120.

In some embodiments, a computer program 530 comprises instructions, which when executed by the at least one processor 510, cause the at least one processor 510 of the network node 110, 120 to perform the actions above.

In some embodiments, a respective carrier 540 comprises the respective computer program 530, wherein the carrier 540 is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, 120, described below may refer to a combination of analogue and digital circuits, and/or one or more processors configured with software and/or firmware, e.g., stored in the network node 110, 120, that when executed by the respective one or more processors such as the at least one processor 510 described above cause the respective at least one processor 510 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

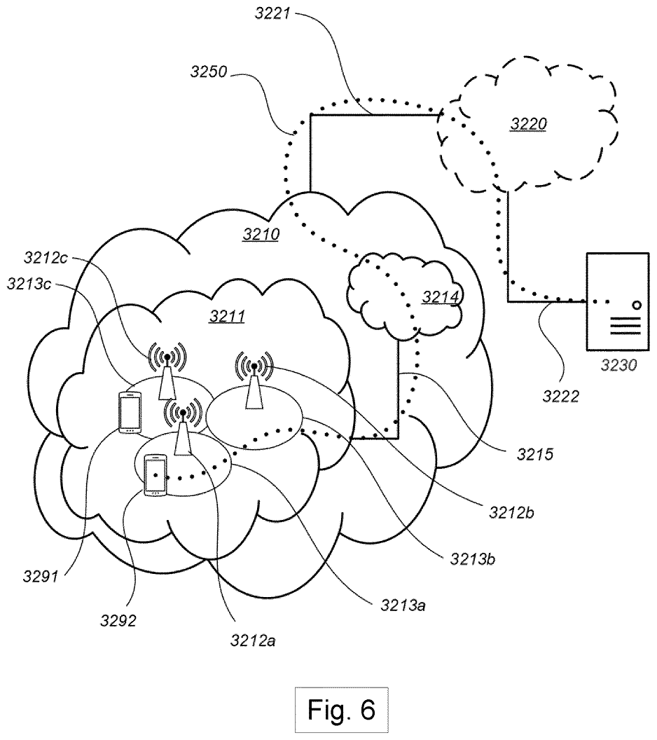

With reference to FIG. 6, in accordance with an embodiment, a communication system includes a telecommunication network 3210, such as a 3GPP-type cellular network, e.g. wireless communications network 100, which comprises an access network 3211, such as a radio access network, and a core network 3214. The access network 3211 comprises a plurality of base stations 3212a, 3212b, 3212c, e.g., the network node 110, 120, such as AP STAs NBs, eNBs, gNBs or other types of wireless access points, each defining a corresponding coverage area 3213a, 3213b, 3213c. Each base station 3212a, 3212b, 3212c, is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c, e.g., the network node 110, 120. A second UE 3292, e.g., any of the one or more second UEs 122, such as a Non-AP STA in coverage area 3213a is wirelessly connectable to the corresponding base station 3212a, e.g., the network node 110, 120. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

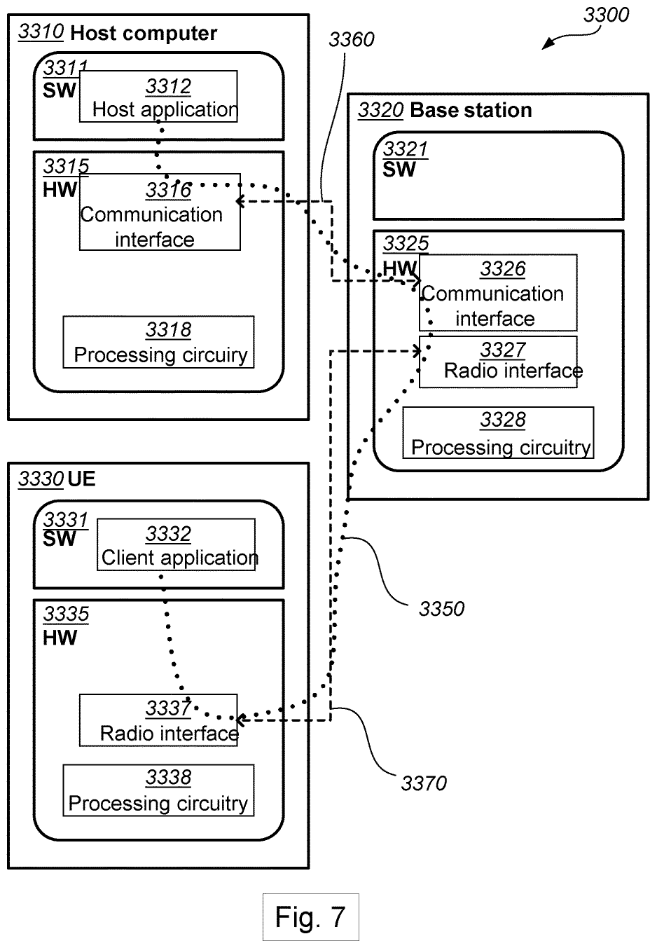

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 6 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

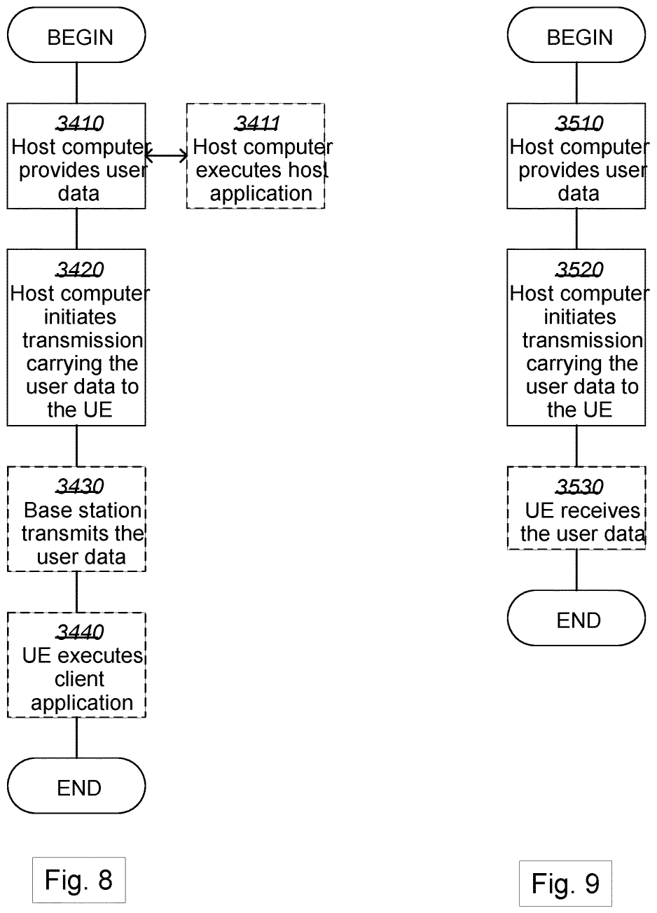

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 8 will be included in this section. In a first Step 3410 of the method, the host computer provides user data. In an optional sub Step 3411 of the first Step 3410, the host computer provides the user data by executing a host application. In a second Step 3420, the host computer initiates a transmission carrying the user data to the UE. In an optional third Step 3430, the base station transmits to the UE the user data which was carried in the transmission that the host computer initiated, in accordance with the teachings of the embodiments described throughout this disclosure. In an optional fourth Step 3440, the UE executes a client application associated with the host application executed by the host computer.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 9 will be included in this section. In a first Step 3510 of the method, the host computer provides user data. In an optional sub step (not shown) the host computer provides the user data by executing a host application. In a second Step 3520, the host computer initiates a transmission carrying the user data to the UE. The transmission may pass via the base station, in accordance with the teachings of the embodiments described throughout this disclosure. In an optional third Step 3530, the UE receives the user data carried in the transmission.

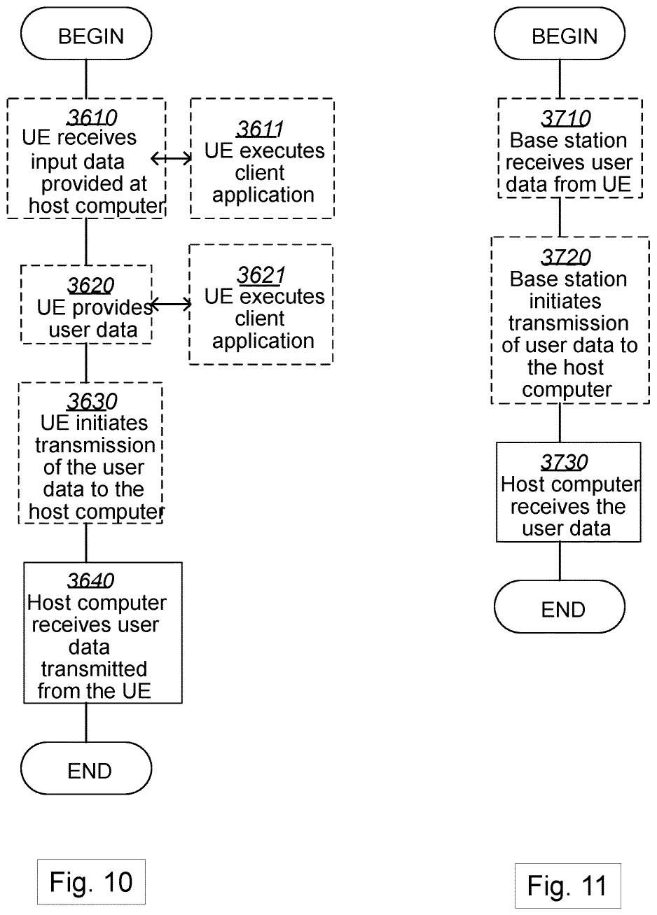

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 10 will be included in this section. In an optional first Step 3610 of the method, the UE receives input data provided by the host computer. Additionally or alternatively, in an optional second Step 3620, the UE provides user data. In an optional sub Step 3621 of the second Step 3620, the UE provides the user data by executing a client application. In a further optional sub Step 3611 of the first Step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub Step 3630, transmission of the user data to the host computer. In a fourth Step 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 11 will be included in this section. In an optional first Step 3710 of the method, in accordance with the teachings of the embodiments described throughout this disclosure, the base station receives user data from the UE. In an optional second Step 3720, the base station initiates transmission of the received user data to the host computer. In a third Step 3730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a network node for handling beam squint in multiple carrier frequencies supported by the network node in a wireless communications network, the method comprising:
obtaining a set of beam tables comprising a beam table for each carrier frequency out of the multiple carrier frequencies supported by the network node,
obtaining from the set of beam tables, a beam table designed for a primary carrier frequency comprised in the multiple carrier frequencies, which primary carrier frequency is for predetermined critical data,
performing the predetermined critical data transmissions to and/or receptions from a UE on the primary carrier frequency, by applying the obtained beam table designed for the primary carrier frequency and thereby being prevented from beam squint,
performing predetermined less critical data transmissions to and/or receptions from the UE on one or more secondary carrier frequencies comprised in the multiple carrier frequencies, by applying the obtained beam table relating to the primary carrier frequency and thereby suffering from beam squint.

2. The method according to claim 1, wherein the obtaining the beam table designed for the primary carrier frequency is performed when any one out of:
starting a Radio Access Network, RAN, in which the network node is operating,
restarting the RAN in which the network node is operating,
deciding to change which carrier frequency is allocated as primary carrier frequency.

3. The method according to claim 1, wherein any one or more out of:
the primary carrier frequency for predetermined critical data comprises at least one or more out of synchronisation data, broadcast data, and control data, and
the one or more secondary carrier frequencies, for less critical data, comprise user data, a number of supporting signaling, and broadcast data.

4. The method according to claim 1, further comprising any one or more out of:
storing the set of beam tables in the network node, and
obtaining information about the primary carrier frequency for predetermined critical data, which primary carrier frequency is comprised in the multiple carrier frequencies.

5. The method according to claim 4, wherein the obtaining information about the primary carrier frequency for predetermined critical data, comprises: obtaining information about two or more primary carrier frequencies for predetermined critical data, which two or more primary carrier frequencies are comprised in the multiple carrier frequencies.

6. The method according to claim 5, wherein the obtaining from the set of beam tables, the beam table relating to the primary carrier frequency comprises obtaining from the set of beam tables, any one out of:
a respective beam table for each of the two or more allocated primary carrier frequencies, or
a respective beam table for at least some of the two or more allocated primary carrier frequencies, or
a beam table to be used for all of the two or more allocated primary carrier frequencies.

7. The method according to claim 5, wherein the performing of the predetermined critical data transmissions to and/or receptions on the primary carrier frequency, by applying the obtained beam table relating to the primary carrier frequency and thereby being prevented from beam squint comprises: performing the predetermined critical data transmissions to and/or receptions on the two or more primary carrier frequencies, by applying the respective obtained beam table relating to the two or more primary carrier frequencies and thereby being prevented from beam squint.

8. The method according to claim 1, wherein the obtained beam table designed for the primary carrier frequency is stored in the network node.

9. A computer program comprising instructions, which when executed by a processor, causes the processor to perform actions according to claim 1.

10. A carrier comprising the computer program of claim 9, wherein the carrier is one of an electronic signal, an optical signal, an electromagnetic signal, a magnetic signal, an electric signal, a radio signal, a microwave signal, or a computer-readable storage medium.

11. A network node configured to handle beam squint in multiple carrier frequencies supported by the network node in a wireless communications network, the network node further being configured to:
obtain a set of beam tables comprising a beam table for each carrier frequency out of the multiple carrier frequencies supported by the network node,
obtain from the set of beam tables, a beam table designed for a primary carrier frequency comprised in the multiple carrier frequencies, which primary carrier frequency is adapted to be for predetermined critical data,
perform the predetermined critical data transmissions to, and/or receptions from, a UE on the primary carrier frequency, by applying the obtained beam table designed for the primary carrier frequency and thereby being prevented from beam squint,
perform predetermined less critical data transmissions to and/or receptions from the UE on one or more secondary carrier frequencies comprised in the multiple carrier frequencies, by applying the obtained beam table relating to the primary carrier frequency and thereby suffering from beam squint.

12. The network node according to claim 11, further configured to obtain the beam table designed for the primary carrier frequency when any one out of:
starting a Radio Access Network, RAN, in which the network node is operating,
restarting the RAN in which the network node is operating,
deciding to change which carrier frequency is allocated as primary carrier frequency.

13. The network node according to claim 11, wherein any one or more out of:
the primary carrier frequency for predetermined critical data is adapted to comprise at least one or more out of synchronisation data, broadcast data, and control data, and
the one or more secondary carrier frequencies, for less critical data, is adapted to comprise user data, a number of supporting signaling, and broadcast data.

14. The network node according to claim 11, further configured to any one or more out of:
store the set of beam tables in the network node, and
obtain information about the primary carrier frequency for predetermined critical data, which primary carrier frequency is adapted to be comprised in the multiple carrier frequencies

15. The network node according to claim 14, further configured to obtain the information about the primary carrier frequency for predetermined critical data, by: obtaining information about two or more primary carrier frequencies for predetermined critical data, which two or more primary carrier frequencies are adapted to be comprised in the multiple carrier frequencies.

16. The network node according to claim 15, further configured to obtain from the set of beam tables, the beam table relating to the primary carrier frequency by obtaining from the set of beam tables, any one out of:
a respective beam table for each of the two or more allocated primary carrier frequencies, or
a respective beam table for at least some of the two or more allocated primary carrier frequencies, or
a beam table to be used for all of the two or more allocated primary carrier frequencies.

17. The network node according to claim 15, further configured to perform the predetermined critical data transmissions to and/or receptions on the primary carrier frequency, by applying the obtained beam table relating to the primary carrier frequency and thereby being prevented from beam squint, is performed by: performing the predetermined critical data transmissions to and/or receptions on the two or more primary carrier frequencies, by applying the respective obtained beam table relating to the two or more primary carrier frequencies and thereby being prevented from beam squint.

18. The network node according to claim 11, wherein the obtained beam table designed for the primary carrier frequency is adapted to be stored in the network node.
